(19) United States
(12) Patent Application Publication
(10) Pub. No.: US 2020/0274931 A1
(43) Pub. Date: Aug. 27, 2020

(54) DEVICE MANAGEMENT APPARATUS AND SYSTEM FOR REMOTELY MANAGING INTERNET OF THINGS DEVICE

(71) Applicant: ASAHI KASEI KABUSHIKI KAISHA, Tokyo (JP)

(72) Inventor: Shiro KOBAYASHI, Menlo Park, CA (US)

(73) Assignee: ASAHI KASEI KABUSHIKI KAISHA, Tokyo (JP)

(21) Appl. No.: 16/288,076

(22) Filed: Feb. 27, 2019

(51) Int. Cl. H04L 29/08; H04W 4/70; H04W 4/38

(52) U.S. Cl. CPC H04L 67/125; H04W 4/38; H04W 4/70

(57) ABSTRACT

A device management apparatus for remotely managing an IoT device is provided. The device management apparatus includes an information acquisition unit configured to connect with a sensor, a network unit configured to connect with a network, and a processor connected to the information acquisition unit and the network unit. The information acquisition unit transmits information acquired by the sensor to the processor. The processor determines whether the information includes a command, and if the command is detected, the processor extracts the command, assesses an applicability of the command, and, depending on the applicability of the command, implements the command or send a query to a server via the network unit.

### TECHNICAL FIELD

This disclosure generally relates generally to a device management apparatus and a system that can be remotely manage an Internet-of-Things (IoT) device.

### BACKGROUND

There have been an attempt to connect objects such as sensors, home appliances and meters to exchange various information or data therebetween over a communication network including an ad-hoc system and the internet. Such network of the object is commonly referred to as the Internet of things (IoT).

When a new IoT device is installed, the device often needs to setup its network configuration suitable for the network environment in which the device is installed. To connect the network, a user is required to, for example, select network name (SSID) and input login credentials (username, and password) with an input device such as a physical/virtual keyboard and a controller having buttons. As the IoT devices have been adopted to smaller objects, it is difficult that the devices are equipped with the input device. Instead of using traditional input devices, so-called “smart home devices” often uses a human voice to activate/control the device. Moreover, US 2012/0069202 A1 discloses a camera management device provided with an image receiving unit that receives image data from a network camera. If control information for controlling the network camera is included in the image data, a control transmitting unit transmits a control command according to the control information to the network camera via the network.

### SUMMARY

To initially configure the smart home device, a user firstly presses a button on the device and turns the smart home device into a setup mode where the device functions as a base station. Then the user connects a terminal such as a table and a smartphone to the device and input necessary network credential information. The device switches to an operation mode when the button is pressed again, or a predetermined waiting period is expired. It is, however, inconvenient since the smart home device needs to have two mode, i.e., the setup mode and the operation mode, and the user needs to access the device for pressing the button.

Some IoT devices are placed in a public space. For example, IoT devices having a loudspeaker for playing audio data stored in the devices or received via the network have been widely used in museums, exhibits, kiosks and digital signage to retail stores. To maximize its acoustic field, the device is often mounted on a ceiling or at a high location on a wall, which make it difficult to access the device. Other IoT devices for monitoring environmental conditions such as temperature, illuminance, and noise are often installed in less accessible places in order to avoid any disturbances. These devices, however, need initial setups when they are installed, and certain reconfigurations afterwards. It is, therefore, preferable that the device can be managed without physically accessing to it. In addition, since the device is placed in a public space and exposed to the public space, its security is a serious concern.

Wifi Protected Setup (WPS) is a known protocol for connecting wireless devices easier. WPS is a simple and convenient way to connect devices to a small closed wireless network, but would be troublesome when used with a Wifi router covering a wide range including a public space.

It is therefore an object of the disclosure to provide a secured device and a secured system that can remotely manage an IoT device without physically accessing thereto.

In one aspect of the disclosure, there is provided a device management apparatus for remotely managing an IoT device, the apparatus comprising an information acquisition unit configured to connect with a sensor, a network unit configured to connect with a network, and a processor connected to the information acquisition unit and the network unit, wherein the information acquisition unit transmits information acquired by the sensor to the processor, the processor determines whether the information includes a command, and if the command is detected, the processor extracts the command, assesses an applicability of the command, and, depending on the applicability of the command, implements the command or send a query to a server via the network unit.

The sensor may be an image sensor, an optical sensor, an acoustic sensor, a heat sensor, or a proximity sensor. The sensor may be equipped in the device management apparatus and provided exclusively for the sake of managing the IoT device. Any sensor originally equipped in the IoT device for implementing its function may also be used. From the view point of space and cost savings, the latter is preferable.

A user can send a command to the sensor in various manner. When an image sensor is used as the sensor, an image such as a two-dimensional barcode may be used. Hand gestures may be used to represent a command.

An optical sensor such as an illuminance sensor, a visible light photosensor, and an RGB color sensor may also be used as the sensor. The optical sensor typically has a photo diode or a photo transistor which can detect invisible high frequency lights and/or invisible chromatic changes. Due to the characteristics of the optical sensor, it is possible to transmit an invisible light signal containing a command to the optical sensor so that the command can be easily distinguished from optical information, such as the illuminance level, to be monitored by the IoT device without being noticed by people surrounding the IoT device.

An acoustic sensor capable of detecting acoustic waves may also be used as the sensor. A typical example of an acoustic sensor is a microphone. A modern microphone often has a frequency response range covering both audible frequencies and higher frequencies up to 20 kHz. A technique known as non-audible acoustic communication uses the non-audible sound having a frequency range between 15 kHz and 20 kHz as a communication medium. With this technique, the command can be easily distinguished from acoustic information, such as the noise level, to be monitored by the IoT device without being noticed by people surrounding the IoT device.

A heat sensor may also be used as the sensor. A non-contact thermal sensor may be recited by way of example. The thermal sensor measures infrared radiation which is emitted by a heat source and has energy corresponding to the temperature of the heat source. To send a command to the sensor, a device capable of emitting light in the infrared range such as an IR LED may be used. The IR LED is driven to transmit a digital signal at a frequency within the sampling frequency of the thermal sensor. For example, the IR LED is turned on and off at a frequency of 10 Hz to create a signal “01010101”, which is used as a preamble signal to synchronize transmission timing between the IR LED and the thermal sensor, and a subsequent signal representing the command. As the infrared radiation caused by people surrounding the IoT device has lower frequency than 10 Hz, the command can be easily distinguished from thermal information, such as the environmental temperature, to be monitored by the IoT.

The sensor can be a proximity sensor. A suitable example of the proximity sensor is, but not limited to, a human detection sensor for detecting the presence/absence of a human. Various types can be used, including an optical type sensor having a combination of a light-emitting element (e.g., LED) and a light-receiving element (e.g., photo diode) to sense a light reflection from an object, an ultrasonic transducer having an ultrasonic transmitter and a receiver to sense an ultrasonic reflection from an object, and a thermal type sensor having a heat sensor to detect a heat from an object. The human detection sensor generally detects some seconds of a continuous presence/absence of a human, and therefore any signal change in a short period such as less than one second is not regarded as a state change and is ignored. However, the sensing element used in the proximity sensor is often capable of following the signal change in less than one second. To send a command to the sensor, a transmitting device capable of emitting light, heat (infrared radiation), or ultrasonic waves may be used. The transmitting device sends out binary coded signals as rapid on/off pulses of light, heat (infrared radiation), or ultrasonic waves at a cycle of less than one second. For example, the transmitting device sends out a signal “01010101”, which is used as a preamble signal to synchronize transmission timing between the transmitting device and the proximity sensor, and a subsequent signal representing the command. As the rapid on/off pulses of light are unnoticeable and the infrared radiation and the ultrasonic waves are invisible, the command can be easily distinguished from the absence/presence of a human monitored by the IoT device without being noticed by people surrounding the IoT device.

The network unit may be a wireless or wired network adapter known per se. The network may be internet, extranet, intranet, and ad-hoc net. A cellular network module may also be used.

The device management apparatus may further include a database unit storing a command reference table, and the processor assesses an applicability of the command with reference to the command reference table. The command reference table includes commands and conditions for each command under which the command can be implemented. The command reference table may be loaded to the database unit prior to or during the installation of the device management apparatus. The command reference table may be modified locally or remotely via the network after the installation.

The processor may collect statuses of the r device management apparatus such as connection to the network, operation mode, security level, current time, current location and the like. The statuses may be used for assessing an applicability of the command with reference to the command reference table.

The device management apparatus may further include an output unit configured to connect with the IoT device and output a signal for implementing the command to the IoT device upon receiving an instruction from the processor.

The device management apparatus may be a peripheral device separated from the IoT device. Alternatively, the device management apparatus may be integrated into the IoT device.

In another aspect of the disclosure, there is provided a system for remotely managing an IoT device, comprising an information acquisition unit for acquiring information from a sensor, a terminal processor connected with the information acquisition unit, and a server connected with the terminal processor via a network, wherein the information acquisition unit transmits information acquired by the sensor to the processor, the terminal processor determines whether the information includes a command, and if the command is detected, the processor extracts the command, assesses an applicability of the command, and depending on the applicability of the command, implements the command or sends a query to the server via the network, the server assesses an applicability of the command, and depending on the applicability of the command, sends an authorization or unauthorization to the terminal processor via the network, and the terminal processor implement the command if the authorization is received.

The sensor may be an image sensor, an optical sensor, an acoustic sensor, a heat sensor, or a proximity sensor as discussed above with reference to the device management apparatus. The sensor may be provided exclusively for the sake of managing the IoT device. Any sensor originally equipped in the IoT device for implementing its function may also be used. From the view point of space and cost savings, the latter is preferable.

The network may be internet, extranet, intranet, and ad-hoc net via wireless or wired connection. A cellular network module may also be used.

The system may further include a terminal database unit storing a first command reference table, and the terminal processor assesses an applicability of the command with reference to the first command reference table. The first command reference table includes possible commands and applicability for each command identifying if no authorization or an authorization from the server is needed to implement the command. The first command reference table may be initially loaded to the terminal database unit. Alternatively, the first command reference table may be loaded to the terminal database locally or from the server via the network after the system is installed. The first command reference table may be modified locally or remotely as needed.

The terminal processor may collect statuses of the system such as connection to the network, operation mode, security level, current time, current location and the like. The statuses may be used for assessing an applicability of the command with reference to the command reference table.

The system may further include an output unit configured to connect with the IoT device and output a signal for implementing the command to the IoT device.

The system may further include a server database unit storing a second command reference table, and the server assesses an applicability of the command with reference to the second command reference table. The second command reference table includes possible commands and applicability for each command identifying if the command can be implemented under a certain condition. An operator may update the second command reference table as needed. For example, when a maintenance of the site where the IoT device is installed is scheduled and the time for accepting commands needs to be changed, the operator may change date and time of such maintenance may be added to the second command reference table.

The system may be combined with the above-mentioned remote management system.

The device management apparatus and system disclosed herein integrate the computer technology into a practical application and improve the operability of the IoT device without physically accessing thereto.

These and other aspects may be understood more readily from the following description and the appended drawings.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram showing one embodiment of a system for remotely managing internet of things device according to the present disclosure.

FIG. 2 shows an example of a command reference table stored in a database unit of the system for remotely managing the IoT device according to the present disclosure.

FIG. 3 shows an example of a device reference table used in the system for remotely managing the IoT device according to the present disclosure.

FIG. 4 shows a process flow of one embodiment of the system for remotely managing the IoT according to the present disclosure.

### DETAILED DESCRIPTION

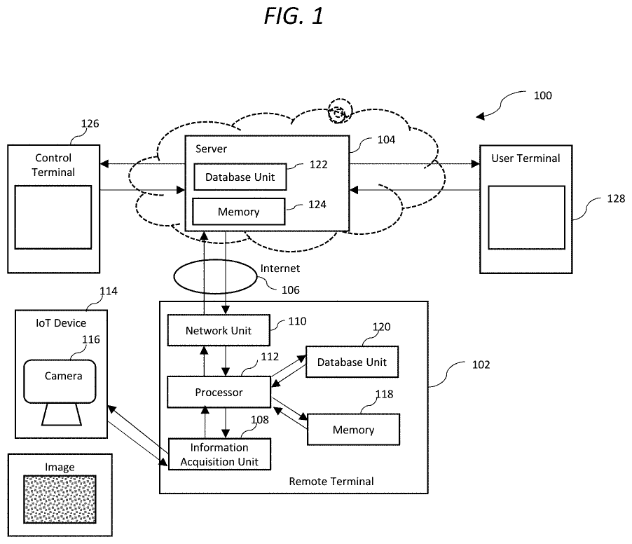

Embodiments will now be described with reference to the drawings. FIG. 1 is a block diagram showing one embodiment of a system for remotely managing internet of things device according to the present disclosure.

A system 100 includes a remote terminal 102 functioning as a device management apparatus and a server 104 connected with the remote terminal 102 via internet 106. The remote terminal 102 is installed at a site such as a shopping mall, a supermarket, and a museum, and the server 104 is housed in a remote location such as a data center.

The remote terminal 102 has an information acquisition unit 108, a network unit 110, and a processor 112. The information acquisition unit 108 communicates with an IoT device 114 and receives image data captured by a camera 116 of the IoT device 114. In this embodiment, the network unit 110 is a wireless network adapter capable of connecting to internet via a wireless router (not shown).

The remote terminal 102 also has a memory 118 which stores a status table. The status table includes network connection status, operation mode, security level, current time, and location. Factory default values of the status table are: <network connection status: not connected>, <operation mode: setup mode>, <security level: high>, and <location: none>. The current time is updated by a built-in clock (not shown) in a real time manner.

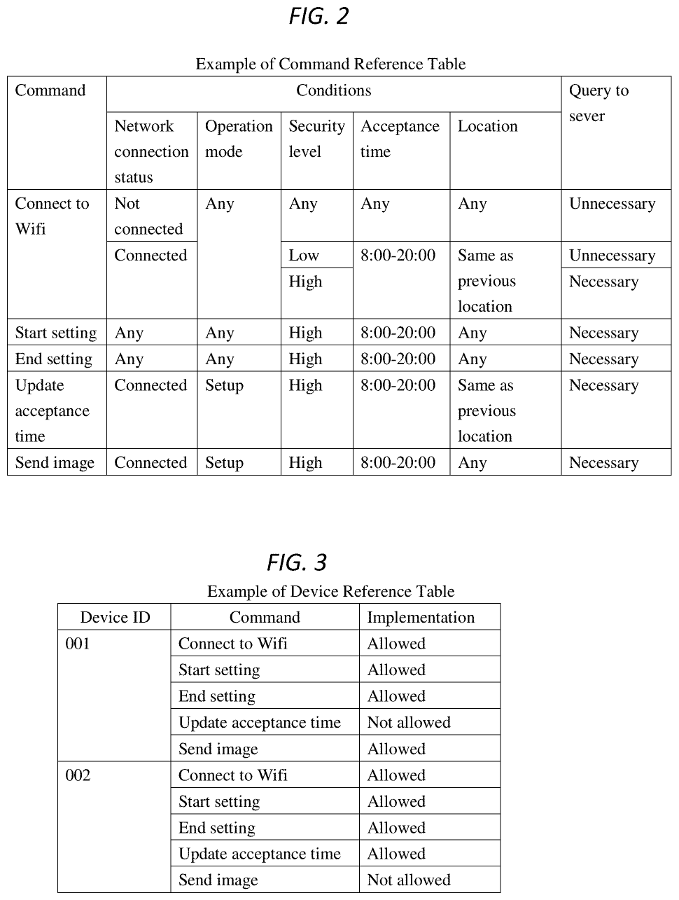

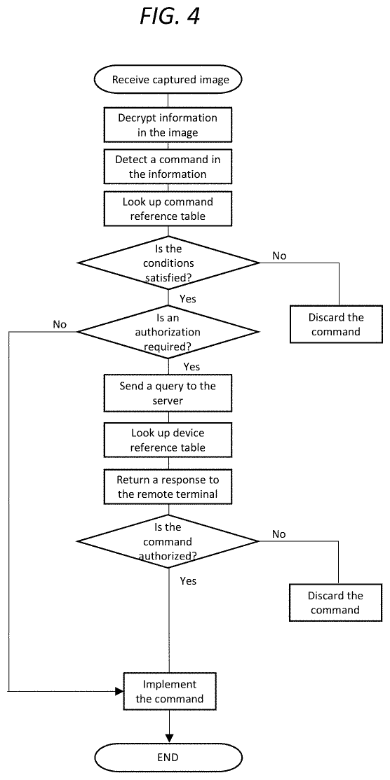

The remote terminal 102 further has a database unit 120 which stores a command reference table such as the one shown in FIG. 2. The command reference table includes commands and conditions for each command under which the command can be implemented.

To send a command to the system 100, a user shows, for example, a two-dimensional barcode containing an encrypted command. The camera 116 captures the barcode image and send it to the information acquisition unit 108, and the information acquisition unit 108 transfers the information contained in the barcode to the processor 112.

The processor 112 decrypts the information and determine whether any command is included in the information. If the command is detected, the processor 112 extracts the command and looks up the command reference table. For example, when the command is a “Connect to Wifi” command accompanying credentials of a particular network, the processor 112 forwards the command to the database unit 120. The database unit 120 then retrieves the conditions for an implementation under the “Connect to Wifi” command from the command reference table and sends it back to the processor 112. The conditions for the “Connect to Wifi” command are, for example, <network connection status: not connected>, <operation mode: any>, <security level: any>, <acceptance time: between 8:00 and 20:00>, and <location: any>.

The processor 112 also reads out actual statuses from the status table. If the remote terminal 102 has never been setup and the command is sent at 19:00, the actual statuses are <network connection status: not connected>, <operation mode: setup mode>, <security level: high>, <time: 19:00> and <location: None>.

The processor 112 then assesses an applicability of the command sent by the user. The assessment is done by comparing the retrieved conditions and the actual statuses. In this case, all of the retrieved conditions are satisfied and the query to server is indicated as unnecessary, the processor determines that the command is implementable and sends the accompanying credentials to the network unit 110 to connect to the specified network. Once the network connection is established, the processor obtains the location information such as “Palo Alto, Calif.” through, for example, the Wifi positioning system and updates the status table to <network connection status: connected>, <operation mode: running mode>, <security level: high>, and <location: Palo Alto, Calif.>. Also, the remote terminal 102 establishes communication with the server 104.

If a malicious user tries to connect the remote terminal 102 to a fraudulent network by presenting a phony two-dimensional barcode containing the “Connect to Wifi” command, the SSID and passcode of the fraudulent network after the site where the remote terminal 102 is installed is closed, for example at 23:00, the processor 112 detects the command and forwards it to the data base unit 120. The data base unit 120 then retrieves the conditions for an implementation under the “Connect to Wifi” command from the command reference table and sends it back to the processor 112. The condition for an implementation under the “Connect to Wifi” command is, for example, <network connection status: connected>, <operation mode: any>, <security level: low>, <time: between 8:00 and 20:00>, and <location: same as previous location>.

The processor 112 reads out actual statuses from the status table, which are <network connection status: connected>, <operation mode: running mode>, <security level: high>, <time: 23:00>, and <location: Palo Alto, Calif.>. The processor 112 then assesses an applicability of the command in the two-dimensional barcode. In this case, the actual time “23:00” is out of the acceptance time “between 8:00 and 20:00” in the command reference table, so that the processor 112 determines that the command is not implementable and the remote terminal 102 discards the command and waits the next command presented to the camera 116.

When the remote terminal 102 needs to connect to a different network due to, for example, a maintenance of the site where the remote terminal 102 is installed, a user can show a two-dimensional barcode containing a “Connect to Wifi” command and accompanying credentials of a particular network within the acceptance time specified for the “Connect to Wifi” command, for example, 10:00 in order to switch the network. The remote terminal 102 follows the steps as discussed above, and the processor 112 assesses an applicability of the command in the two-dimensional barcode. In this case, all of the statuses satisfy the respective conditions in the command reference table and the query to server is indicated as necessary, so that the remote terminal 102 sends query including a device identification (device ID), such as an IMEI number, and the command to the server 104.

The server 104 has a database unit 122 which stores a device reference table such as the one shown in FIG. 3. When the server 104 receives the query from the remote terminal 102, the server 104 retrieves the device reference table for the device ID from the database unit 122 and stores it in a memory 124. Then, the server 104 assesses an applicability of the command. In this case, the command “Connected to Wifi” is indicated as “Allowed” in the device reference table, so that the server 104 determines that the command is applicable and returns an authorization to the remote terminal 102 via internet 106. Upon receiving the authorization, the remote terminal 102 implements the command, i.e., disconnects from the current network and connects to the new network with using the credentials of the new network accompanying the command.

The remote terminal 102 may have a timer which starts at the time the query is sent. If the timer reaches a given time, such as 5 seconds, before the authorization from the server is received, the remote terminal 102 discards the command to enhance the security of the system and waits the next command presented to the camera 116.

Once the network status of the remote terminal 102 is confirmed, the operator may logon to the server from a control terminal such as a mobile phone and update the “Implementation” field under the “Connect to Wifi” command for this device (device ID: 001) from “Allowed” to “Not allowed” to avoid a further network change due to an accidental or unauthorized presentation of the barcode.

A barcode image containing a “Send image” command may also be presented to the camera 116, for example, in order to adjust the posture of the IoT device 114. Upon implementation of the command, the camera 116 captures an image and the image is sent to the server 104 via internet 106. The server 104 stores the image to a storage area assigned to each device or forwards the image to the control terminal 126 of the operator. In the former case, the operator may logon to the server from the control terminal 126 to access the image on the server. Alternatively, the remote terminal sends the image direct to a user terminal 128 via internet 106.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A device management apparatus for remotely managing an IoT device, the apparatus comprising an information acquisition unit configured to connect with a sensor, a network unit configured to connect with a network, and a processor connected to the information acquisition unit and the network unit,
wherein the information acquisition unit transmits information acquired by the sensor to the processor,
the processor determines whether the information includes a command, and if the command is detected, the processor extracts the command, assesses an applicability of the command, and, depending on the applicability of the command, implements the command or send a query to a server via the network unit.

2. The device management apparatus according to claim 1, wherein the sensor is at least one of an image sensor, an optical sensor, an acoustic sensor, a heat sensor, and a proximity sensor.

3. The device management apparatus according to claim 1, wherein the sensor is equipped in the device management apparatus.

4. The device management apparatus according to claim 1, wherein the sensor is equipped in the IoT device.

5. The device management apparatus according to claim 1, further comprising a database unit storing a command reference table.

6. The device management apparatus according to claim 1, further comprising an output unit configured to connect with the IoT device.

7. The device management apparatus according to claim 1, wherein the device management apparatus is a peripheral apparatus separated from the IoT device.

8. The device management apparatus according to claim 1, wherein the device management apparatus is integrated into the IoT device.

9. A system for remotely managing an IoT device, comprising an information acquisition unit for acquiring information from a sensor, a terminal processor connected with the information acquisition unit, and a server connected with the terminal processor via a network,
wherein the information acquisition unit transmits information acquired by the sensor to the processor,
the terminal processor determines whether the information includes a command, and if the command is detected, the processor extracts the command, assesses an applicability of the command, and depending on the applicability of the command, implements the command or sends a query to the server via the network,
the server assesses an applicability of the command, and depending on the applicability of the command, sends an authorization or unauthorization to the terminal processor via the network, and the terminal processor implement the command if the authorization is received.

10. The system according to claim 9, wherein the sensor is at least one of an image sensor, an optical sensor, an acoustic sensor, a heat sensor, and a proximity sensor.

11. The system according to claim 9, wherein the sensor is equipped in the IoT device.

12. The system according to claim 9, further comprising a terminal database unit storing a first command reference table.

13. The system according to claim 9, further comprising an output unit configured to connect with the IoT device.

14. The system according to claim 9, further comprising a server database unit storing a second command reference table.

15. A system for remotely managing an IoT device, comprising the device management apparatus according to claim 1 and a server connected with the terminal processor via a network,
Wherein the server assesses an applicability of the command, and depending on the applicability of the command, sends an authorization or unauthorization to the terminal processor via the network, and the terminal processor implement the command if the authorization is received.
